(19) United States
(12) Patent Application Publication
(10) Pub. No.: US 2017/0345011 A1
(43) Pub. Date: Nov. 30, 2017

(54) SYSTEM AND METHOD EXECUTED ON A BLOCKCHAIN NETWORK

(71) Applicant: Hitfin, Inc., San Francisco, CA (US)

(72) Inventors: Patrick S. Salami, San Francisco, CA (US); Nathalie A. Salami, San Francisco, CA (US)

(73) Assignee: Hitfin, Inc., San Francisco, CA (US)

(21) Appl. No.: 15/166,156

(22) Filed: May 26, 2016

(51) Int. Cl. G06Q 20/42; G06Q 20/06; G06Q 20/10; G06Q 20/38

(52) U.S. Cl. CPC G06Q 20/42; G06Q 20/381; G06Q 20/065; G06Q 20/10

(57) ABSTRACT

A blockchain network includes first, second, third computers and a server computer at first, second, third and fourth blockchain nodes, respectively. An initial state is processed with a service provider computer by entering a spot rate of a price of a first currency relative to a price of second currency on the blockchain. A trade entry is processed with the first market participant computer by entering contract terms for a contract. The first and second market participant computers process first and second trade affirmations by entering an affirmation of the contract terms. A mark to market is processed with the service provider computer by entering a mark to market rate. All the blockchain nodes validate a signature and contract value received from the service provider computer. A settlement is processed and balances of first and second market participants are updated on the blockchain nodes.

### BACKGROUND OF THE INVENTION

### 1). Field of the Invention

This invention relates to a system and method executed on a blockchain network.

### 2). Discussion of Related Art

Cryptocurrency and blockchain platforms such as the Bitcoin network and the Ethereum network have been developed for purposes of transferring cryptocurrency between participants. The currency unit of the Ethereum network is called Ether and is primarily used to charge for computational costs.

The Ethereum network supports smart contracts. Smart contracts are computer protocols that facilitate, verify, or enforce the negotiation or performance of a contract. Smart contracts may, in theory, be made partially or fully self-executing, self-enforcing, or both. Smart contracts may provide security that is superior to traditional contracts and may reduce other transaction costs associated with contracting.

### SUMMARY OF THE INVENTION

The invention provides a method executed with a first participant computer in a block chain network with first, second, third participant computers and a service computer at first, second, third and fourth blockchain nodes, respectively, including processing an initial state for an initial date with the first market participant computer by receiving a message with the initial state at the first blockchain node, including a datum value determined with the service provider computer, processing a trade entry for a maturity date with the first market participant computer by entering contract terms of a contract, the contract terms including a datum value and a number of units, and sending the trade entry with the contract terms to the second, third and fourth blockchain nodes, processing a first trade affirmation for a first trade affirmation date with the first market participant computer by entering an affirmation by a first market participant of the contract terms, and sending the first trade affirmation to the second, third and fourth blockchain nodes, processing a second trade affirmation for a second trade affirmation date with the first market participant computer by receiving the second trade affirmation at the first blockchain node including an affirmation by a second market participant of the contract terms entered, processing a mark to market for a mark to market date with the first market participant computer by receiving a contract value of the mark to market at the first blockchain node with a signature following a determination of a mark to market rate of a datum value, a calculation of the contract value based on the number of units and the mark to market rate, and a storing the contract value by the service provider computer, and receiving a validation of the contract value and signature at the first blockchain node following the validation of the contract value and the signature with the third participant computer system and processing a settlement for a settlement date with the first market participant computer, wherein the transfer is reflected on the first blockchain node by transferring an amount between balances of the first and second market participants based on the contract value for the mark to market date if the contract value and signature are validated by the third participant computer system.

The invention also provides a first market participant computer in a block chain network with first, second, third participant computers and a service computer at first, second, third and fourth blockchain nodes, respectively, wherein an initial state for an initial date is processed with the first market participant computer by receiving a message with the initial state at the first blockchain node, including a datum value determined with the service provider computer, a trade entry for a maturity date is processed with the first market participant computer by entering contract terms of a contract, the contract terms including a datum value and a number of units, and sending the trade entry with the contract terms to the second, third and fourth blockchain nodes, a first trade affirmation for a first trade affirmation date is processed with the first market participant computer by entering an affirmation by a first market participant of the contract terms, and sending the first trade affirmation to the second, third and fourth blockchain nodes, a second trade affirmation for a second trade affirmation date is processed with the first market participant computer by receiving the second trade affirmation at the first blockchain node including an affirmation by a second market participant of the contract terms entered, a mark to market for a mark to market date is processed with the first market participant computer by receiving a contract value of the mark to market at the first blockchain node with a signature following a determination of a mark to market rate of a datum value, a calculation of the contract value based on the number of units and the mark to market rate, and a storing the contract value by the service provider computer and a settlement for a settlement date is processed by transferring an amount between balances of the first and second market participants based on the contract value for the mark to market date, if the contract value and signature are validated by the third participant computer system, wherein the transfer is reflected on the first blockchain node.

The invention further provides a method executed with a second participant computer in a block chain network with first, second, third participant computers and a service computer at first, second, third and fourth blockchain nodes, respectively, including processing an initial state for an initial date with the second market participant computer by receiving a message with the initial state at the second blockchain node, including a datum value determined with the service provider computer, processing a trade entry for a maturity date with the second market participant computer by receiving the trade entry with contract terms at the second blockchain node following entering of the contract terms of a contract by the first participant computer, the contract terms including a datum value and a number of units, processing a first trade affirmation for a first trade affirmation date with the second market participant computer by receiving the first trade affirmation at the second blockchain node following entering of an affirmation by a first market participant of the contract terms, processing a second trade affirmation for a second trade affirmation date with the second market participant computer by entering an affirmation by a second market participant of the contract terms, and sending the second trade affirmation to the first, third and fourth blockchain nodes, processing a mark to market for a mark to market date with the second market participant computer by receiving a contract value of a mark to market at the second blockchain node with a signature, and following a determination of a mark to market rate of a price of the first commodity relative to a price of the second commodity, a calculation of the contract value based on the number of units and the mark to market rate, and storing the contract value by the service provider computer, and receiving a validation of the contract value and signature at the second blockchain node following the validation of the contract value and the signature with the third participant computer system and processing a settlement for a settlement date with the second market participant computer, wherein a transfer is reflected on the second blockchain node by transferring an amount between balances of the first and second market participants based on the contract value for the mark to market date if the contract value and signature are validated by the third participant computer system.

The invention also provides a second market participant computer in a block chain network with first, second, third participant computers and a service computer at first, second, third and fourth blockchain nodes, respectively, wherein an initial state for an initial date is processed with the second market participant computer by receiving a message with the initial state at the second blockchain node, including a datum value determined with the service provider computer, a trade entry for a maturity date is processed with the second market participant computer by receiving the trade entry with contract terms at the second blockchain node following entering of the contract terms of a contract by the first participant computer, the contract terms including a datum value and a number of units, a first trade affirmation for a first trade affirmation date is processed with the second market participant computer by receiving the first trade affirmation at the second blockchain node following entering of an affirmation by a first market participant of the contract terms, a second trade affirmation for a second trade affirmation date is processed with the second market participant computer by entering an affirmation by a second market participant of the contract terms, and sending the second trade affirmation to the first, third and fourth blockchain nodes, a mark to market for a mark to market date is processed with the second market participant computer by receiving a contract value of a mark to market at the second blockchain node with a signature following a determination of a mark to market rate of a price of the first commodity relative to a price of the second commodity, a calculation of the contract value based on the number of units and the mark to market rate, and storing the contract value by the service provider computer, and a settlement for a settlement date is processed by transferring an amount between balances of the first and second market participants based on the contract value for the mark to market date, if the contract value and signature are validated by the third participant computer system, wherein the transfer is reflected on the second blockchain node.

The invention further provides a method executed with a third participant computer in a block chain network with first, second, third participant computers and a service computer at first, second, third and fourth blockchain nodes, respectively, including processing an initial state for an initial date with the third market participant computer by receiving a message with the initial state at the third blockchain node, including a datum value determined with the first market participant computer, processing a trade entry for a maturity date with the third market participant computer by receiving the trade entry with contract terms at the third blockchain node following entering of the contract terms of a contract by the first participant computer, the contract terms including a datum value and a number of units, processing a first trade affirmation for a first trade affirmation date with the third market participant computer by receiving the first trade affirmation at the third blockchain node following entering of an affirmation by a first market participant of the contract terms, processing a second trade affirmation for a second trade affirmation date with the third market participant computer by receiving the second trade affirmation at the third blockchain node including an affirmation by a second market participant of the contract terms entered, processing a mark to market for a mark to market date with the third market participant computer by receiving a contract value of a mark to market at the third blockchain node with a signature following a determination of a mark to market rate of a price of the first commodity relative to a price of the second commodity, a calculation of the contract value based on the number of units and the mark to market rate, and a storing the contract value by the service provider computer, and by validating the contract value received from the service provider computer and the signature, and sending the validation of the contract value and signature to the first, second and fourth blockchain nodes; and processing a settlement for a settlement date with the third market participant computer, wherein the transfer is reflected on the third blockchain node by transferring an amount between balances of the first and second market participants based on the contract value for the mark to market date if the contract value and signature are validated by the third participant computer system.

The invention also provides a third market participant computer in a block chain network with first, second, third participant computers and a service computer at first, second, third and fourth blockchain nodes, respectively, wherein an initial state for an initial date is processed with the third market participant computer by receiving a message with the initial state at the third blockchain node, including a datum value determined with the first market participant computer; a trade entry for a maturity date is processed with the third market participant computer by receiving the trade entry with contract terms at the third blockchain node following entering of the contract terms of a contract by the first participant computer, the contract terms including a datum value and a number of units, a first trade affirmation for a first trade affirmation date is processed with the third market participant computer by receiving the first trade affirmation at the third blockchain node following entering of an affirmation by a first market participant of the contract terms, a second trade affirmation for a second trade affirmation date is processed with the third market participant computer by receiving the second trade affirmation at the third blockchain node including an affirmation by a second market participant of the contract terms entered, a mark to market for a mark to market date is processed with the third market participant computer by receiving a contract value of a mark to market at the third blockchain node with a signature, and following a determination of a mark to market rate of a price of the first commodity relative to a price of the second commodity, a calculation of the contract value based on the number of units and the mark to market rate, and storing the contract value by the service provider computer and a settlement for a settlement date is processed by transferring an amount between balances of the first and second market participants based on the contract value for the mark to market date, if the contract value and signature are validated by the third participant computer system, wherein the transfer is reflected on the third blockchain node.

The invention further provides a method executed with a service computer in a block chain network with first, second, third participant computers and a service computer at first, second, third and fourth blockchain nodes, respectively, including processing an initial state for an initial date with the service provider computer by determining a datum value, and sending a message with the initial state to the first, second and third blockchain nodes, processing a trade entry for a maturity date with the service provider computer by receiving the trade entry with contract terms at the fourth blockchain node following entering of the contract terms of a contract by the first participant computer, the contract terms including a datum value and a number of units, processing a first trade affirmation for a first trade affirmation date with the service provider computer by receiving the first trade affirmation at the fourth blockchain node following entering of an affirmation by a first market participant of the contract terms, processing a second trade affirmation for a second trade affirmation date with the service provider computer by receiving the second trade affirmation at the fourth blockchain node including an affirmation by a second market participant of the contract terms entered an affirmation by a second market participant of the contract terms, processing a mark to market for a mark to market date with the service provider computer by determining a mark to market rate of a price of the first commodity relative to a price of the second commodity, calculating a contract value based on the number of units and the mark to market rate, storing the contract value, and sending the contract value of the mark to market to the first, second and third blockchain nodes with a signature, and receiving a validation of the contract value and signature at the second blockchain node following the validation of the contract value and the signature with the third participant computer system and processing a settlement for a settlement date with the service provider computer, wherein the transfer is reflected on the fourth blockchain node by transferring an amount between balances of the first and second market participants based on the contract value for the mark to market date if the contract value and signature are validated by the third participant computer system.

The invention also provides a service provider computer in a block chain network with first, second, third participant computers and a service computer at first, second, third and fourth blockchain nodes, respectively, wherein an initial state for an initial date is processed with the service provider computer by determining a datum value, and sending a message with the initial state to the first, second and third blockchain nodes, a trade entry for a maturity date is processed with the service provider computer by receiving the trade entry with contract terms at the fourth blockchain node following entering of the contract terms of a contract by the first participant computer, the contract terms including a datum value and a number of units, a first trade affirmation for a first trade affirmation date is processed with the service provider computer by receiving the first trade affirmation at the fourth blockchain node following entering of an affirmation by a first market participant of the contract terms, a second trade affirmation for a second trade affirmation date is processed with the service provider computer by receiving the second trade affirmation at the fourth blockchain node including an affirmation by a second market participant of the contract terms entered an affirmation by a second market participant of the contract terms, a mark to market for a mark to market date is processed with the service provider computer by determining a mark to market rate of a price of the first commodity relative to a price of the second commodity, calculating a contract value based on the number of units and the mark to market rate, storing the contract value, and sending the contract value of the mark to market to the first, second and third blockchain nodes with a signature and a settlement for a settlement date is processed by transferring an amount between balances of the first and second market participants based on the contract value for the mark to market date, if the contract value and signature are validated by the third participant computer system, wherein the transfer is reflected on the fourth blockchain node.

The invention further provides a method executed in a blockchain network with first, second, third participant computers and a service computer at first, second, third and fourth blockchain nodes, respectively, including processing an initial state for an initial date with the service provider computer by determining a datum value, and sending a message with the initial state to the first, second and third blockchain nodes, processing a trade entry for a maturity date with the first market participant computer by entering contract terms of a contract, the contract terms including a datum value and a number of units, and sending the trade entry with the contract terms to the second, third and fourth blockchain nodes, processing a first trade affirmation for a first trade affirmation date with the first market participant computer by entering an affirmation by a first market participant of the contract terms, and sending the first trade affirmation to the second, third and fourth blockchain nodes, processing a second trade affirmation for a second trade affirmation date with the second market participant computer by entering an affirmation by a second market participant of the contract terms, and sending the second trade affirmation to the first, third and fourth blockchain nodes, processing a mark to market for a mark to market date with the service provider computer by determining a mark to market rate of a price of the first commodity relative to a price of the second commodity, calculating a contract value based on the number of units and the mark to market rate, storing the contract value, and sending the contract value of the mark to market to the first, second and third blockchain nodes with a signature, and with the third participant computer system by validating the contract value received from the service provider computer and the signature, and sending the validation of the contract value and signature to the first, second and fourth blockchain nodes and processing a settlement for a settlement date by transferring an amount between balances of the first and second market participants based on the contract value for the mark to market date, if the contract value and signature are validated by the third participant computer system, wherein the transfer is reflected on the first, second, third and fourth blockchain nodes.

The invention further provides a block chain network comprising first, second, third participant computers and a service computer at first, second, third and fourth blockchain nodes, respectively, wherein an initial state for an initial date is processed with the service provider computer by determining a datum value, and sending a message with the initial state to the first, second and third blockchain nodes, a trade entry for a maturity date is processed with the first market participant computer by entering contract terms of a contract, the contract terms including a datum value and a number of units, and sending the trade entry with the contract terms to the second, third and fourth blockchain nodes, a first trade affirmation for a first trade affirmation date is processed with the first market participant computer by entering an affirmation by a first market participant of the contract terms, and sending the first trade affirmation to the second, third and fourth blockchain nodes, a second trade affirmation for a second trade affirmation date is processed with the second market participant computer by entering an affirmation by a second market participant of the contract terms, and sending the second trade affirmation to the first, third and fourth blockchain nodes, a mark to market for a mark to market date is processed with the service provider computer by determining a mark to market rate of a price of the first commodity relative to a price of the second commodity, calculating a contract value based on the number of units and the mark to market rate, storing the contract value, and sending the contract value of the mark to market to the first, second and third blockchain nodes with a signature, and with the third participant computer system by validating the contract value received from the service provider computer and the signature, and sending the validation of the contract value and signature to the first, second and fourth blockchain nodes, and a settlement for a settlement date is processed by transferring an amount between balances of the first and second market participants based on the contract value for the mark to market date, if the contract value and signature are validated by the third participant computer system, wherein the transfer is reflected on the first, second, third and fourth blockchain nodes.

The invention also provides a method of updating a balance, including distributing a computer code to a plurality of nodes, distributing a first state to first and second ones of the nodes such that each node has a copy of the first state, causing a state transition from the first state to a second state at the first node, the state transition including a determination of a transfer amount and an adjustment of a balance based on the transfer amount, transmitting at least an indication of the state transition from the first node to a validation node other than the first node, receiving the indication of the state transition from the first node at the validation node, calculating, with the computer code at the validation node, the second state and updating the state on the second node to the second state if the state transition calculated by the validation node matches the state transition of the first node.

### BRIEF DESCRIPTION OF THE DRAWINGS

The invention is further described by way of example with reference to the accompanying drawings, wherein:

FIGS. 1A and B are a block diagram illustrating processing of an initial state on a blockchain;

FIG. 2 is a view similar to FIG. 1 illustrating processing of a trade entry on the blockchain;

FIG. 3 is a view similar to FIG. 2 illustrating processing of a first trade affirmation on the blockchain;

FIG. 4 is a view similar to FIG. 3 illustrating processing of a second trade affirmation on the blockchain;

FIG. 5A is a view similar to FIG. 4 illustrating processing of a mark to market on the blockchain;

FIG. 5B shows a state transition at one node;

FIG. 5C(i)-(iii) shows blockchain nodes in three phases;

FIG. 6 is a view similar to FIG. 5 illustrating processing of a settlement on the blockchain;

FIG. 7 is a flowchart illustrating a process of the invention at a high level; and

FIG. 8 is a block diagram of a machine in the form of a computer system forming part of a blockchain network.

### DETAILED DESCRIPTION OF THE INVENTION

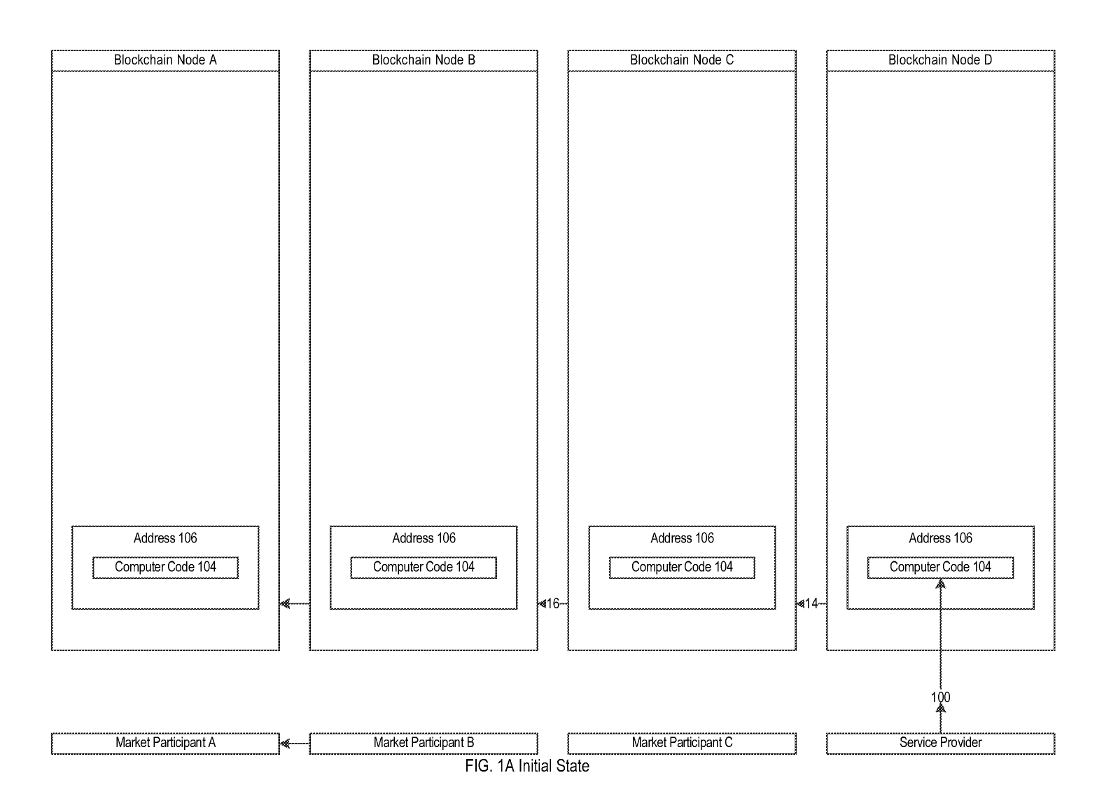

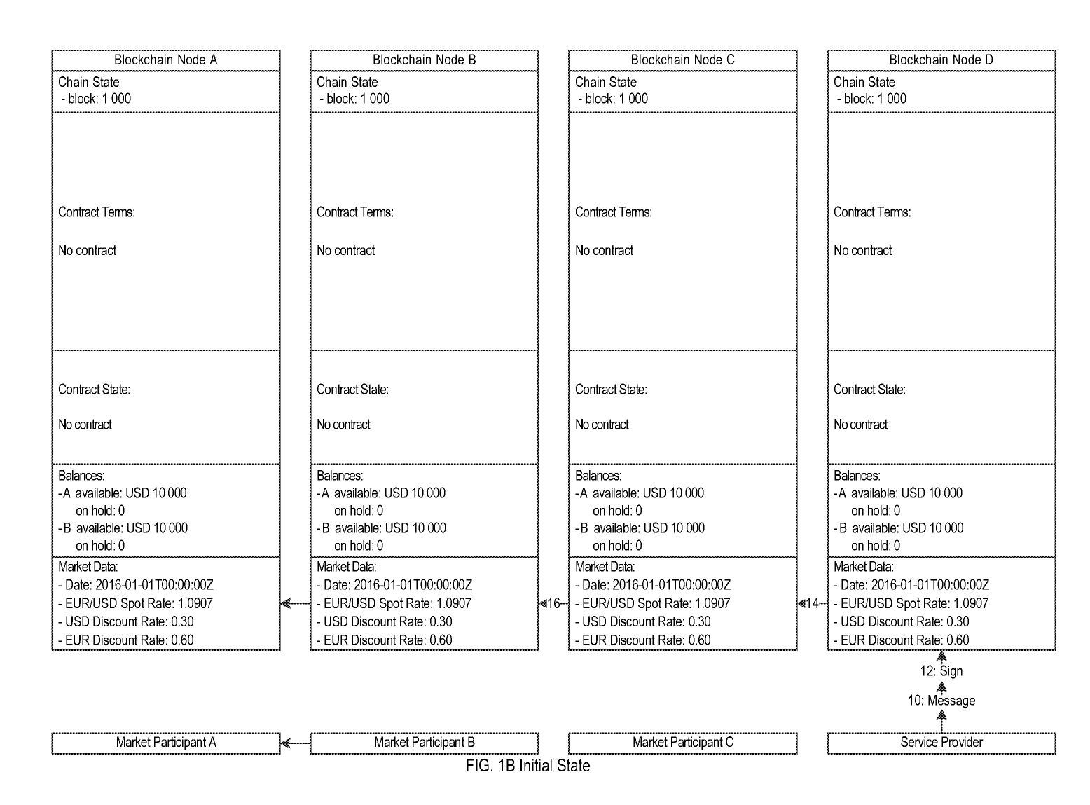

FIG. 1 of the accompanying drawings illustrates a blockchain, according to an embodiment of the invention, that includes first, second, third and fourth blockchain nodes (blockchain nodes A to D), first second and third market participant computers (market participant A to C) and a service provider computer (service provider).

The first, second and third participant computers are located at the first to third blockchain nodes, respectively and the service provider computer is located at the fourth blockchain node. The first blockchain node may be separate from the first market participant computer or the first blockchain node may be located on the first market participant computer. Similarly, the second, third and fourth blockchain nodes may be separate the second market participant computer, third market participant computer and service provider computer, respectively, or may be located on the respective computers. One or more of the first to fourth blockchain nodes may be located in a separate country than the other blockchain nodes or the blockchain nodes may all be located in the same country. The first blockchain node is shown as being located at the first market participant computer. However, the first blockchain node and the first market participant computer may be physically separated and may be located in separate countries, provided that the first market participant computer controls the first blockchain node and receives information from the first blockchain node. Similarly, the second, third and fourth blockchain nodes may be physically separated and may be located in different countries from their respective computers.

The first and second blockchain nodes are controlled by first and second market participant computers, respectively. Each blockchain node includes balances for the first and second market participants. The balances are synchronized (synced) across blockchain nodes. In the present embodiment the balance represents a cryptographic token that is backed by a fiat currency in the form of United States Dollar (USD) deposits made by the market participants and that the token can be exchanged for the fiat currency 1:1. In another embodiment the balance can refer to other assets such as Bitcoin, Ether, government notes, other contracts, etc. The present example describes a forward contract of datum values in the form of currency exchange rates. Another embodiment may use datum values for other forward or future contracts such as the price of a commodity or weather data, or datum values for contracts other than forward or future contracts. “Commodity” may include fiat currencies, virtual currencies, other assets or synthetic instruments represented by price data feeds.

### Initial State

FIGS. 1A and B illustrate an initial state that has been processed using primarily the service provider computer and the first, second, third and fourth blockchain nodes. In the present example, the initial state is processed for an initial date, as represented by the time and date 2016-Jan.-1T00:00:00Z. The service provider computer determines a spot rate of a price of a first currency relative to a price of second currency. In another embodiment the service provider computer may determine a spot rate of a price of a first commodity other than a currency (e.g., the price of corn) relative to a price of second commodity other than a currency (e.g., the price of sugar).

First and second transactions 100 and 102 take place in order to set up the initial state. As shown in FIG. 1A, the first transaction 100 deploys computer code 104 to the blockchain that contains the computer instructions needed to settle a forward contract between two market participants but does not yet contain the detailed parameters of the agreement. The first transaction 100 causes new executable computer code 104 to be written to the blockchain, which can later be called by other transactions. The first transaction 100 in effect creates a new blockchain account address 106 that represents an account that contains the new executable computer code 104.

As shown in FIG. 1B, the second transaction records the initial spot exchange rate and discount rates on the blockchain. The service provider computer first determines an initial transaction. The initial transaction contains the byte-code representation of a computer program. The byte-code comprises instructions for a virtual machine. Respective copies of the virtual machine runs on the first, second, third and fourth blockchain nodes. The computer program is written in a Turing-complete computer programming language and is compiled to byte-code on the service provider computer. The processing of the first transaction on each respective blockchain node causes a new account to be created. The new account is identified by a unique blockchain address 106 and further contains the byte-code representation of the computer code 104. Blockchain addresses are used to identify accounts. Such accounts may be controlled by the first or second market participants or the service provider. In cases where the account contains a computer program, the account is controlled by neither the market participants nor the service provider, and the account instead controlled only by such computer program, the computer program always executing the same instructions with the same state on each respective blockchain node, thereby behaving as if it were in fact itself an autonomous actor.

The ability to deploy and execute a custom Turing-complete computer program in such manner on the blockchain, rather than on a single node, is a required feature of the blockchain implementation used in the present example because of the ability for the blockchain to uniquely enable the particular automated contract settlement described herein without relying on any one trusted entity to settle the contract.

The computer program described in the present example is an implementation of a derivatives contract known as a forward contract. The computer program implements a function to enter detailed information about a specific agreement between two market participants. The detailed information includes a trade date, a fixing date, a forward rate, a ticker symbol that identifies the spot rate of a price of the first commodity, here USD currency, relative to the price of the second commodity, here EUR currency, the number of units, the settlement currency, the collateral type, the collateral currency, the initial margin amount, and the contract type, which together represent certain contractual agreements between market participants. The detailed information further includes the blockchain account addresses of the long and the short side of the contract, respectively. In another embodiment, additional detailed information may be recorded and used as part of the contract settlement process such as, for example, business day conventions and information to determine how a contract should be closed out in case one of the counter-parties is in default. In addition, a cryptographic hash of a written agreement between the counter-parties that governs the terms of the contract may also be recorded as part of the detailed information.

The computer program implements a function to enter a trade affirmation for the long side of the contract or the short side of the contract. The function verifies that the blockchain address of the sender of the function call matches the blockchain address of the long side of the contract or the short side of the contract, respectively. The computer program further implements a function that updates market data, computes the notional value of the contract and marks to market or settles a contract by providing the current spot rate of a price of a first currency relative to the price of a second currency and discount rates for the respective currencies. The function determines a present value of the contract based on the spot rate, the discount rates, and the present date relative to the contract maturity date. The function further computes the present notional value of the contract, which is used to determine the amount of variation margin to be exchanged between the market participant holding the long side of the contract and the market participant holding the short side of the contract. The function causes the actual exchange of the computed variation margin to take place. The function further initiates a final contract settlement if the present date is equal to or greater than the contract maturity date. The final contract settlement includes a final exchange of variation margin, a release of initial margin holds, and a marking of the contract as settled so no further contract valuation, mark to market or variation margin exchange actions can take place.

The service provider signs the first transaction with an elliptic curve digital signature algorithm (ECDSA) signature and sends the first transaction with its signature to the fourth blockchain node. ECDSA is a well-known asymmetric cryptographic algorithm defined by National Institute for Standards and Technology (NIST) in Federal Information Processing Standards Publication 186-4 (FIPS 186-4). The fourth blockchain node validates the first transaction and syncs the transaction to the other blockchain nodes. As shown in FIGS. 1A and B, the second node discovers a new block and, as the new block is discovered and synced to each blockchain node, the first transaction that records the computer program on the blockchain is executed on each blockchain node. The execution of the first transaction thereby causes each blockchain node to record the computer code 104 included in the first transaction 100 in an account identified by a unique account address 106 on the blockchain. The account address 106 refers to the same account on each respective copy of the blockchain on each blockchain node, and the account on each respective blockchain node contains the same computer program contained in the first transaction. The computer code 104 included in the first transaction can thereby be executed on each respective blockchain node by sending a transaction to the account having the account address 106 holding the computer code 104 on the respective blockchain node. The account state of the account that includes the computer code 104 that represents the contract is thereby updated to include the computer program.

The service provider computer determines a spot exchange rate of Euro (EUR) to USD of 1.0907. The service provider computer also determines a risk-free interest (discount) rate for the respective currencies. The service provider refers to an external data source that was previously selected and agreed upon by the market participants to determine the spot exchange rate and discount rates. In the present example, the discount rate for USD is determined based on the spot yield at the initial date of a 12-month zero-coupon Treasury note. The Treasury note is a debt instrument issued by the United States Department of the Treasury that repays its bearer its face value after a time period of 12 months after the Treasury note was issued and does not make any interest payments to its bearer. In the present example, the discount rate for EUR is determined based on an estimate of the spot yield at the initial date of a theoretical 12-month zero-coupon bond computed by the European Central Bank based on the market spot yields of AAA-rated bonds issued in EUR by some or all of the nineteen central governments in the Eurozone. Although it is shown that only a single discount rate is determined by the service provider computer for each respective currency, it should be understood that the service provider computer in fact determines the spot rates of multiple zero-coupon bonds by the same issuers with different maturity dates so as to enable a more accurate valuation of contracts that will be entered by the market participants. Multiple spot rates are calculated to later generate a yield curve on the blockchain nodes, which is used to more accurately value a forward contract because forward contract valuation requires knowledge of the interest rate that would be paid between the valuation date and the maturity date. Market data typically exists for fixed maturity dates such as 1-month, 3-months, 6-months and 12-months, which update daily. However, when the contract value is generated, it is often required that the interest rate for a specific time period for which no market data is available is computed. This can be done with a computed yield curve if the interest rates for the fixed maturity dates are known. In another embodiment, the yield curve and contract valuation can also take place entirely on the service provider computer or on some or all of the market participant computers, requiring that the market participants trust each other or the service provider to accurately perform the computations. Further, the determination of the spot exchange rate and discount rates may take place on some or all of the market participant computers, requiring that the market participants separately enter into an agreement that governs the determination and recording of such market data on the blockchain.

At 10, the service provider computer determines a transaction with the name of the market data update function within the computer program that implements a foreign-currency forward contract, identifying the computer program with its unique account address, the unique account address identifying the same account on each blockchain node, and the initial state containing the initial time and date, spot rate and discount rates as inputs to the function. At 12 the service provider computer signs the transaction with an ECDSA signature using a private key controlled only by the service provider and sends the transaction with its signature to the fourth blockchain node. The private key was determined by the service provider as an ECDSA signing key having 256 bits in length by applying the key generation function of ECDSA configured with the parameters of the secp256k1 curve to a random seed value determined by the service provider. The secp256k1 curve refers to well-known parameters of the ECDSA curve defined in Standards for Efficient Cryptography (SEC)(Certicom Research. See www.secg.org/sec2-v2.pdf). The signature was determined by applying the signature function of ECDSA configured with the parameters of the secp256k1 curve to the private key controlled only by the service provider, a unique and deterministic number having 256 bits in length derived by the service provider based on the private key known only to the service provider, a byte-array representation of the complete transaction, and the SHA-256 digest of a byte-array representation of the complete transaction. SHA-256 is a well-known cryptographic algorithm defined by National Institute for Standards and Technology (NIST) in Federal Information Processing Standards Publication 180-4 (FIPS 180-4). The signature is comprised of three components known as v, r, and s, with v being an integer known as a recovery bit between the values 27 and 31 to be used to determine the public key that is derived from the private key that was used to generate the signature, the public key being determined by applying the recovery function of ECDSA to the byte-array representation of the complete transaction with which the signature was generated, the r and s components of the signature, and the recovery bit v. According to FIPS 186-4, ECDSA signatures are only comprised of the values r and s but in Ethereum, bitcoin (and other cases), v is added. V may be used to recover the public key that made the signature, knowing only r, s and the message that was signed (the serialized transaction). It is thereby possible to omit the sender from the transaction data in order to save storage and processing costs and to instead validate implicitly that the sender in fact is also the signer by simply recovering the public key from the signature (the sender address is derived directly from the public key).

The fourth blockchain node receives and validates the transaction by applying the recovery function of ECDSA to the transaction signature and to the message (a byte-array representation of the complete transaction). The transaction signature includes the recovery bit v which together with the message and r and s components of the signature allow for the public key to be extracted. The public key is then used to determine the blockchain address of the sender.

In addition to validating the transaction's signature by recovering the public key as described, each node also performs the following additional steps to validate the transaction:

Each account (each blockchain address) has a nonce that is incremented each time a transaction is recorded that originates from that account. In this step, the node ensures that the nonce included in the transaction is the value that is expected for the sending account. This ensures that each transaction can be applied to the blockchain only once because changing the nonce of the transaction would require a new signature to be made with the sender's private key in order to make the transaction valid.

In the present implementation, each transaction consumes a certain amount of gas, gas being a measure of transaction cost. The sender of the transaction indicates the maximum amount of gas that shall be available to process the transaction. In this step, the node validates that the amount of gas used to process the transaction does not exceed the maximum amount of gas that shall be available to process the transaction, as indicated by the sender.

The cost of the gas used to process the transaction together with any funds that are transferred as part of the transaction are used to compute the total cost of the transaction, denominated in the native currency of the blockchain (not necessarily the settlement currency of the contract). In this step, the node validates that the native currency balance of the sender account is sufficient to cover the cost of the transaction. At 14, the transaction determined at 10 is synced to all the other blockchain nodes. Although it is shown that the transaction is only synced from the fourth blockchain node to the third blockchain node, it should be understood that the fourth blockchain node in effect sends the transaction with the initial state to the first, second and third blockchain nodes. The first, second and third blockchain nodes thus receive the transaction with the initial state including the initial time and date, spot rate and discount rates. The first, second and third blockchain nodes validate the transaction by applying the recovery function of ECDSA to the transaction signature and to the message (a byte-array representation of the complete transaction). The transaction signature includes the recovery bit v which together with the message and r and s components of the signature allow for the public key to be extracted. The public key is then used to determine the blockchain address of the sender. Although it is shown that the validation is only carried out by the second and third blockchain nodes, it should be understood that the validation is carried out by each one of the first, second, and third blockchain nodes separately.

At 16, the third blockchain node discovers a new block including a block header containing the time and date of the block, a reference to the previous block, a hash of the block and the transaction provided at 10 and a nonce that when used as input to the SHA-256 cryptographic algorithm results in a value with certain characteristics, the characteristics determined based on the difficulty at the initial state known to the first, second, third and fourth blockchain nodes and encoded in the header of the newest known block. In order to produce a valid block, it is necessary to find a number (known as the block's nonce) greater than another number that, when applied to the SHA-256 function, produces a hash value with certain characteristics: in the case of the exemplary proof-of-work consensus mechanism, the hash value must begin with a certain number of zeros in order to be valid, the number of zeros increasing with increasing difficulty. The first, second and fourth blockchain nodes receive the block from the third blockchain node and validate the block by applying the SHA-256 function to the block's nonce and ensuring that the result has the required characteristics determined based on the difficulty. When the new block is discovered by and synced to the third blockchain node and the first, second and fourth blockchain nodes, respectively, each blockchain node receives, validates and processes the transaction contained in the block, validating the transaction by applying the recovery function of ECDSA to the transaction signature and to the message (a byte-array representation of the complete transaction). The transaction signature includes the recovery bit v which together with the message and r and s components of the signature allow for the public key to be extracted. The public key is then used to determine the blockchain address of the sender. Each node processes the transaction by executing the market data update function within the computer program recorded on the blockchain at the account address contained in the transaction, within a virtual machine running on the blockchain node, with the initial time and date, spot rate and discount rates as inputs to the function.

In addition to validating the transaction's signature by recovering the public key as described, each node also performs the following additional steps to validate the transaction:

Each account (each blockchain address) has a nonce that is incremented each time a transaction is recorded that originates from that account. In this step, the node ensures that the nonce included in the transaction is the value that is expected for the sending account

In the present implementation, each transaction consumes a certain amount of gas, gas being a measure of transaction cost. The sender of the transaction indicates the maximum amount of gas that shall be available to process the transaction. In this step, the node validates that the amount of gas used to process the transaction does not exceed the maximum amount of gas that shall be available to process the transaction, as indicated by the sender.

The cost of the gas used to process the transaction together with any funds that are transferred as part of the transaction are used to compute the total cost of the transaction, denominated in the native currency of the blockchain (not necessarily the settlement currency of the contract). In this step, the node validates that the native currency balance of the sender account is sufficient to cover the cost of the transaction.

The computer code of the function instructs the blockchain node to store the initial state in the account that contains the computer code on the copy of the blockchain recorded on each respective blockchain node. The first, second, third and fourth blockchain nodes thereby enter the initial state including the initial time and date, spot rate and discount rates so that the initial state on each respective blockchain node is the same. The state of the blockchain is a mapping between account addresses and account states. Each account state comprises a nonce that indicates the number of transactions initiated by the account that were successfully applied to the blockchain, a balance indicating the amount of native virtual currency controlled by the account, a 256-bit hash of the root node of a Merkle Patricia tree that encodes any data that is stored in the account, and a hash of any computer code that is associated with the account. Although not part of the blockchain, it is assumed that the blockchain state is stored in an immutable data structure known as a modified Merkle Patricia tree. The tree stored on each respective blockchain node in a database is known as the state database. The tree contains a root node with a hash value that is cryptographically dependent on all data stored in the tree, thereby allowing any previous blockchain state to be recalled in a trivial manner by recalling the root hash of the state to be recalled.

Each valid transaction, as it is applied to a given state, causes a state transition resulting in a new state. Each block in the blockchain identifies a final state at that block after all transactions in the block have been executed. The blockchain thereby forms a specific type of state machine. The state at each block is derived by applying all transactions within that block to the state of the previous block. The same valid transaction applied to the same state on each respective blockchain node results in the same new state on each respective blockchain node.

### Trade Entry

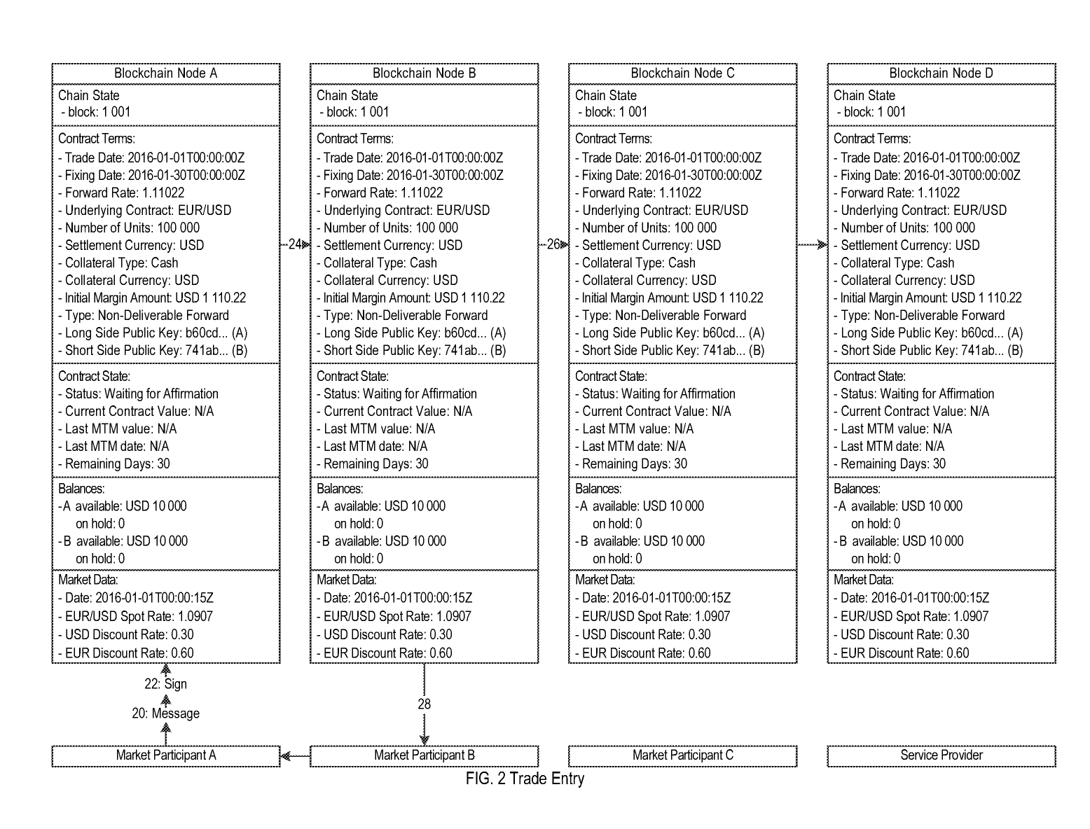

FIG. 2 illustrates the processing of a trade entry using primarily the first and second market participant computers and the first, second, third and fourth blockchain nodes.

The processing of the trade entry is initiated by a market participant using the first market participant computer. The first market participant enters contract terms of a contract on the first market participant computer. The contract terms then form the trade entry. The trade entry is recorded for a particular trade date (2016-Jan.-10T00:00:00Z) and is recorded for a particular maturity date or fixing date (2016-Jan.-30T00:00:00Z). The date of the trade entry may be before the trade date (the date on which the mutual obligations, mark to market and variation margin settlements actually begin). The contract terms include a forward rate of a price of the first currency relative to a price of the second currency (1.11022) and a number of units (100,000). The initial margin amount (USD 1,110.22) is calculated by multiplying the forward rate with the number of units to obtain the notional amount, and then applying the initial margin requirement of 1% to the notional amount. The initial margin requirement is a rate negotiated between the first market participant and the second market participant prior to trade entry and is based upon multiple factors including statutory minimums, the creditworthiness of each market participant relative to the other, the volatility of the contract's underlying asset relative to its maturity, as well as other factors that may be considered as parameters to an initial margin model. In the present example, both the first and second market participants provide the same amount of initial margin. However, in other cases the amount of initial margin provided by each counter-party to a contract may be different for each respective counter-party. The purpose of the initial margin requirement is to protect each market participant in case its counter-party defaults on its contractual obligations. In the case a market participant defaults on its obligations under the contract, the initial margin amount of the defaulting market participant is credited to the balance of the non-defaulting market participant and the contract is closed out, ending any further obligations between the counter-parties under that contract. The contract terms further include the blockchain addresses of the first market participant and the second market participant as well as the settlement currency USD.

At 20, the first market participant computer determines a transaction with the name of the trade entry function within the computer program that implements a foreign-currency forward contract, identifying the computer program with its unique account address, the unique account address identifying the same account on each blockchain node, and the trade entry containing the trade date, the maturity date, the forward rate with the underlying currency pair, the number of units, the initial margin amount, the blockchain addresses of the first market participant and the second market participant, and the settlement currency as inputs to the function. At 22 the market participant using the first market participant computer signs the transaction with an elliptic curve ECDSA signature using a private key controlled only by the first market participant and sends the transaction containing the trade entry and the transaction's signature to the first blockchain node. The first blockchain node receives and validates the signed trade entry transaction, validating the transaction by applying the recovery function of ECDSA to the transaction signature and to the byte-array representation of the complete transaction, the transaction signature including the recovery bit v, using the output of the recovery function to determine the blockchain address of the sender.

In addition to validating the transaction's signature by recovering the public key as described, each node also performs the following additional steps to validate the transaction:

Each account (each blockchain address) has a nonce that is incremented each time a transaction is recorded that originates from that account. In this step, the node ensures that the nonce included in the transaction is the value that is expected for the sending account

In the present implementation, each transaction consumes a certain amount of gas, gas being a measure of transaction cost. The sender of the transaction indicates the maximum amount of gas that shall be available to process the transaction. In this step, the node validates that the amount of gas used to process the transaction does not exceed the maximum amount of gas that shall be available to process the transaction, as indicated by the sender.

The cost of the gas used to process the transaction together with any funds that are transferred as part of the transaction are used to compute the total cost of the transaction, denominated in the native currency of the blockchain (not necessarily the settlement currency of the contract). In this step, the node validates that the native currency balance of the sender account is sufficient to cover the cost of the transaction.

At 24, the first blockchain node syncs the new transaction with the second, third and fourth blockchain nodes. Although it is only shown that the transaction is synced from the first blockchain node to the second blockchain node at 24, it should be understood that the same transaction is sent to the second, third and fourth blockchain nodes and that the second, third and fourth blockchain nodes receive and validate the transaction with the contract terms and contract state so that they are the same as the contract terms and contract state in the first blockchain node.

At 26, the second blockchain node discovers a new block. The first, third and fourth blockchain nodes receive the block from the second blockchain node and validate the block by applying the SHA-256 function to the block's nonce and ensuring that the result has the characteristics determined based on the difficulty. When the new block is discovered by and synced to the second blockchain node and the first, third and fourth blockchain nodes, respectively, each blockchain node once again receives, validates and processes the transaction now contained in the new block, validating the transaction by applying the recovery function of ECDSA to the transaction signature and to the byte-array representation of the complete transaction, the transaction signature including the recovery bit v, using the output of the recovery function to determine the blockchain address of the sender, processing the transaction by executing the trade entry function within the computer program recorded on the blockchain and loaded into the state database at the account address contained in the transaction, within a virtual machine running on the blockchain node, with the parameters of the trade entry as inputs to the function. The computer code of the function instructs the node to store the contract details that form the trade entry as part of the account state of the account that contains the computer code that implements the forward contract and was deployed to the blockchain with the first transaction on the copy of the blockchain recorded on each respective blockchain node. The state of the blockchain is identical on each node after the block is synced and the transaction processed. This means that the data that was stored as part of the transaction on each node's copy of the blockchain was written to the same block in each node's data store and can be accessed as part of the account state of the same account address in each node's, state database. Although not part of the blockchain, it is assumed that each blockchain node also contains its own state database stored as an immutable data structure known as a Merkle Patricia tree. The state database is constructed separately on each node based on the sequence of valid transactions that are committed to each node's copy of the blockchain. The cross-validation of transactions together with the proof-of-work consensus mechanism result in each node having the same state database at any given block that has been finally committed to the blockchain. The memory location of the computer program that contains the trade entry function to be executed is determined on each node based on the account address of the blockchain account that contains the computer code that implements the forward contract.

The function name and parameters are encoded as a byte-array and included in the transaction. By executing the trade entry function, each blockchain node further updates the contract state to reflect “Waiting for Affirmation” from the first and second market participants. The first, second, third and fourth blockchain nodes thereby enter the trade entry so that the trade entry on each respective blockchain node is the same.

In addition to validating the transaction's signature by recovering the public key as described, each node also performs the following additional steps to validate the transaction:

Each account (each blockchain address) has a nonce that is incremented each time a transaction is recorded that originates from that account. In this step, the node ensures that the nonce included in the transaction is the value that is expected for the sending account

In the present implementation, each transaction consumes a certain amount of gas, gas being a measure of transaction cost. The sender of the transaction indicates the maximum amount of gas that shall be available to process the transaction. In this step, the node validates that the amount of gas used to process the transaction does not exceed the maximum amount of gas that shall be available to process the transaction, as indicated by the sender.

The cost of the gas used to process the transaction together with any funds that are transferred as part of the transaction are used to compute the total cost of the transaction, denominated in the native currency of the blockchain (not necessarily the settlement currency of the contract). In this step, the node validates that the native currency balance of the sender account is sufficient to cover the cost of the transaction.

At 28, the second blockchain node notifies the second market participant computer of the new trade entry on the second blockchain node. The second blockchain node may, for example, send an email to the second market participant computer with details of the trade entry. Alternatively, the second market participant may be notified of the new trade entry using alternative channels such as text messaging or social media.

### First Trade Affirmation

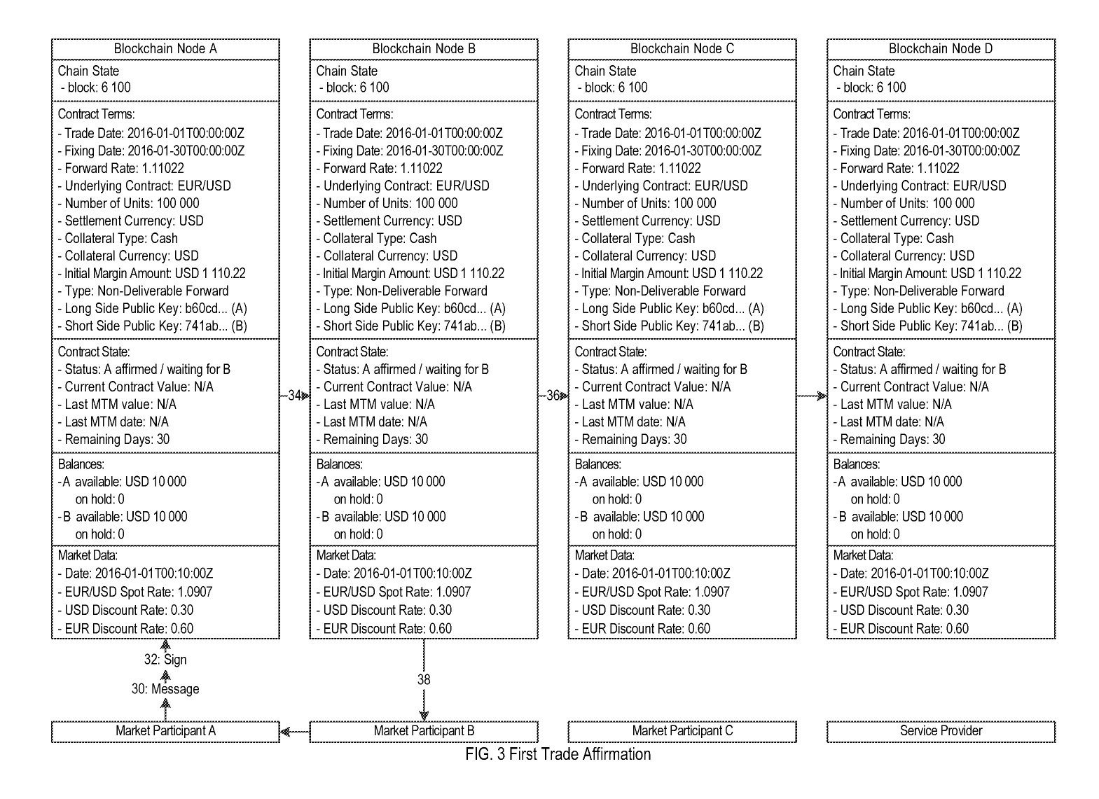

FIG. 3 illustrates a first trade affirmation that is carried out using primarily the first and second market participant computers and the first and second blockchain nodes.

The processing of the first trade affirmation is for a first trade affirmation time and date, which may or may not be the same time and date as the processing of the trade entry in FIG. 2. The first market participant uses the first market participant computer to view the contract terms on the first blockchain node. At 30, the first market participant determines a transaction with the name of the trade affirmation function within the computer program that implements a foreign-currency forward contract, identifying the computer program with its unique account address, the unique account address identifying the same account on each blockchain node, and the trade affirmation containing a unique identifier for the specific contract between the first and second market participants that was entered during the Trade Entry step as inputs to the function. At 32 the market participant using the first market participant computer signs the trade affirmation transaction with an elliptic curve ECDSA signature using a private key controlled only by the first market participant and sends the transaction containing the trade affirmation and the transaction's signature to the first blockchain node. The first blockchain node receives and validates the signed trade affirmation transaction, validating the transaction by applying the recovery function of ECDSA to the transaction signature and to the byte-array representation of the complete transaction, the transaction signature including the recovery bit v, using the output of the recovery function to determine the blockchain address of the sender.

In addition to validating the transaction's signature by recovering the public key as described, each node also performs the following additional steps to validate the transaction:

Each account (each blockchain address) has a nonce that is incremented each time a transaction is recorded that originates from that account. In this step, the node ensures that the nonce included in the transaction is the value that is expected for the sending account.

In the present implementation, each transaction consumes a certain amount of gas, gas being a measure of transaction cost. The sender of the transaction indicates the maximum amount of gas that shall be available to process the transaction. In this step, the node validates that the amount of gas used to process the transaction does not exceed the maximum amount of gas that shall be available to process the transaction, as indicated by the sender.

The cost of the gas used to process the transaction together with any funds that are transferred as part of the transaction are used to compute the total cost of the transaction, denominated in the native currency of the blockchain (not necessarily the settlement currency of the contract). In this step, the node validates that the native currency balance of the sender account is sufficient to cover the cost of the transaction.

At 34, the first blockchain node syncs the new transaction with the second, third and fourth blockchain nodes. Although it is only shown that the transaction is synced from the first blockchain node to the second blockchain node at 34, it should be understood that the same transaction is sent to the second, third and fourth blockchain nodes and that the second, third and fourth blockchain nodes receive and validate the transaction with the trade affirmation so that the contract state is the same as the contract state on the first blockchain node.

At 36, the second blockchain node discovers a new block. The first, third and fourth blockchain nodes receive the block from the second blockchain node and validate the block by applying the SHA-256 function to the block's nonce and ensuring that the result has the characteristics determined based on the difficulty. When the new block is discovered by and synced to the second blockchain node and the first, third and fourth blockchain nodes, respectively, each blockchain node once again receives, validates and processes the transaction now contained in the new block, validating the transaction by applying the recovery function of ECDSA to the transaction signature and to the byte-array representation of the complete transaction, the transaction signature including the recovery bit v, using the output of the recovery function to determine the blockchain address of the sender, processing the transaction by executing the trade affirmation function within the computer program recorded on the blockchain and loaded into the state database at the account address contained in the transaction, within a virtual machine running on the blockchain node. The computer code of the function instructs the node to record the trade affirmation of the first market participant as part of the account state of the account that contains the computer code that implements the forward contract and was deployed to the blockchain with the first transaction on the copy of the blockchain recorded on each respective blockchain node. As described, the state of the blockchain is identical on each node after the block is synced and the transaction processed.

By executing the trade affirmation function called by the first market participant, the contract state on each blockchain node is updated to reflect “Affirmed” by the first market participant and “Waiting” for affirmation from the second market participant.

At 38, the second blockchain node sends a message to the second market participant computer to notify the second market participant computer of the first trade affirmation. The notification may, for example, be by email. Alternatively, the second market participant can be notified using alternative messaging technologies such as text messaging or social media.

### Second Trade Affirmation

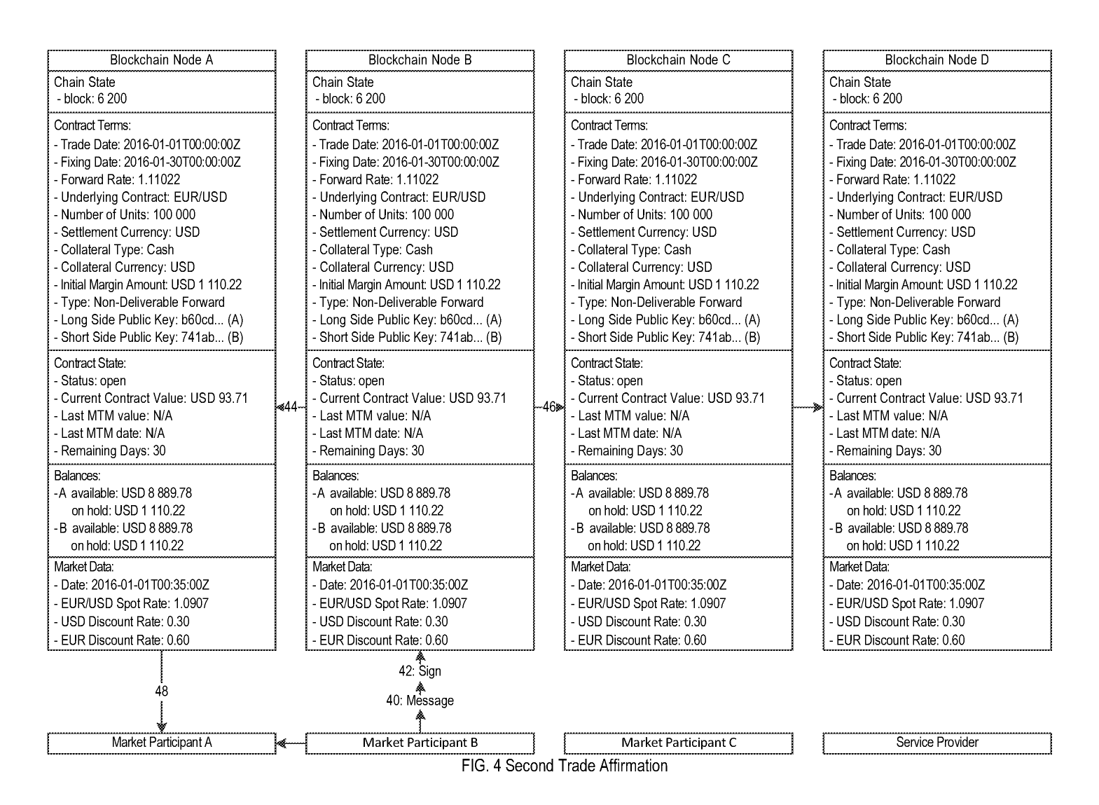

FIG. 4 illustrates a processing of a second trade affirmation using primarily the first and second market participant computers and the first, second, third and fourth blockchain nodes. The second trade affirmation is processed for a second trade affirmation time and date, which may or may not be the same as the first trade affirmation time and date.

The second market participant at the second market participant computer views and verifies the contract terms on the second blockchain node. At 40, the second market participant sends a second trade affirmation to the second blockchain node and at 42 signs the second affirmation with an ECDSA signature using a private key of the second market participant. When both the first and second market participants affirm the contract terms and the current date is greater than the trade date, the contract status is automatically changed to “open”. An “open” contract status reflects affirmed by the first and second market participants. An “open” contract status also causes variation margin to be exchanged between the first and second market participants when the service provider computer sends updated market data until the current date is the same as the contract maturity/fixing date.

At 44, the second blockchain node syncs the new transaction with the first, third and fourth blockchain nodes. Although it is only shown that the transaction is synced from the second blockchain node to the first and third blockchain nodes at 44, it should be understood that the same transaction is sent to the first, third and fourth blockchain nodes and that the first, third and fourth blockchain nodes receive and validate the transaction with the trade affirmation so that the updated contract state and balances are the same as the contract state and balances on the second blockchain node.

At 46, the second blockchain node discovers a new block. The first, third and fourth blockchain nodes receive the block from the second blockchain node and validate the block by applying the SHA-256 function to the block's nonce and ensuring that the result has the characteristics determined based on the difficulty. When the new block is discovered by and synced to the second blockchain node and the first, third and fourth blockchain nodes, respectively, each blockchain node once again receives, validates and processes the transaction now contained in the new block, validating the transaction by applying the recovery function of ECDSA to the transaction signature and to the byte-array representation of the complete transaction, the transaction signature including the recovery bit v, using the output of the recovery function to determine the blockchain address of the sender, processing the transaction by executing the trade affirmation function within the computer program recorded on the blockchain and loaded into the state database at the account address contained in the transaction, within a virtual machine running on the blockchain node. The computer code of the function instructs the node to record the trade affirmation of the second market participant as part of the account state of the account that contains the computer code that implements the forward contract and was deployed to the blockchain with the first transaction on the copy of the blockchain recorded on each respective blockchain node. As described, the state of the blockchain is identical on each node after the block is synced and the transaction processed.

By executing the trade affirmation function called by the second market participant, the contract state on each blockchain node is updated to reflect “open” and the balances of the first and second market participants are updated to reflect a debit from the available balance of each respective market participant in the amount of the initial margin amount of the contract and a credit of the same amount to the on hold balance of each respective market participant.

At 48, the first blockchain node notifies the first market participant of the second trade affirmation.

### Mark to Market

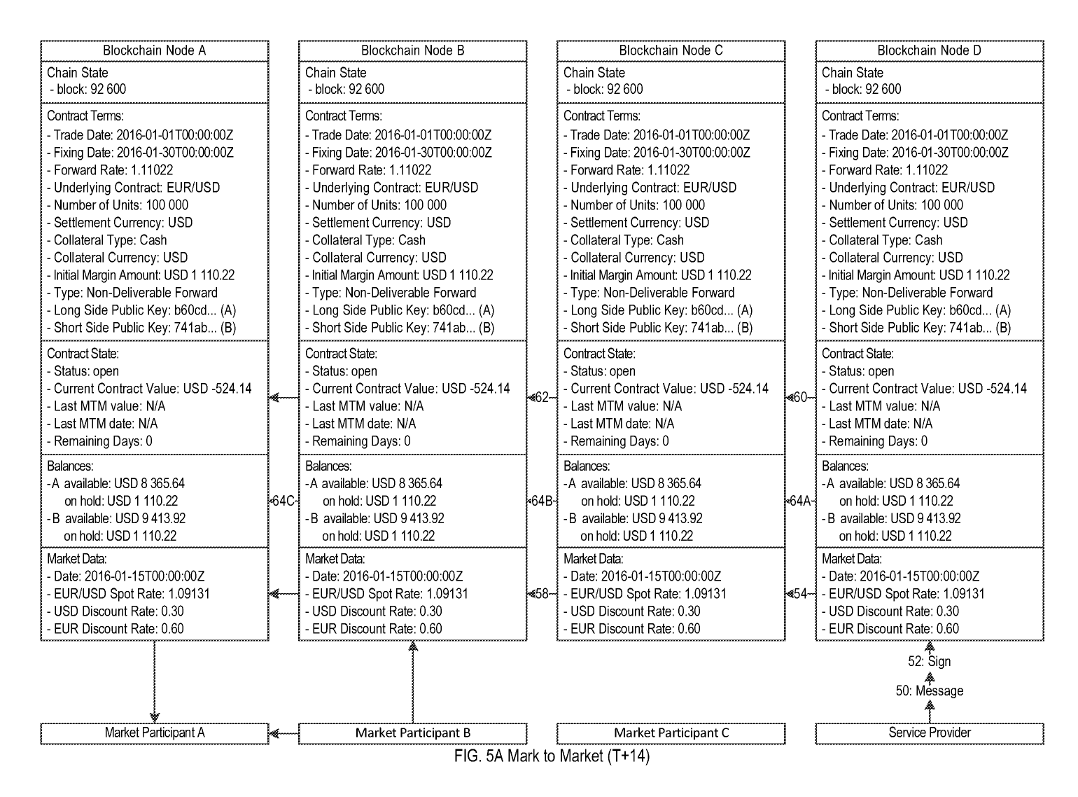

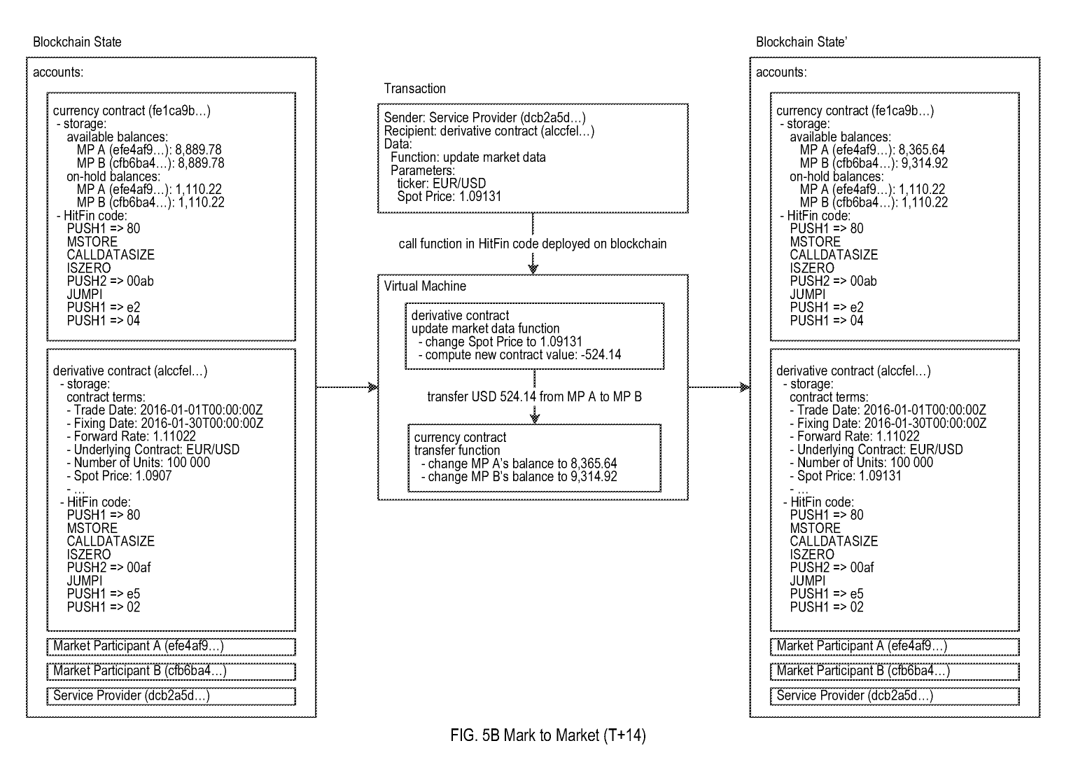

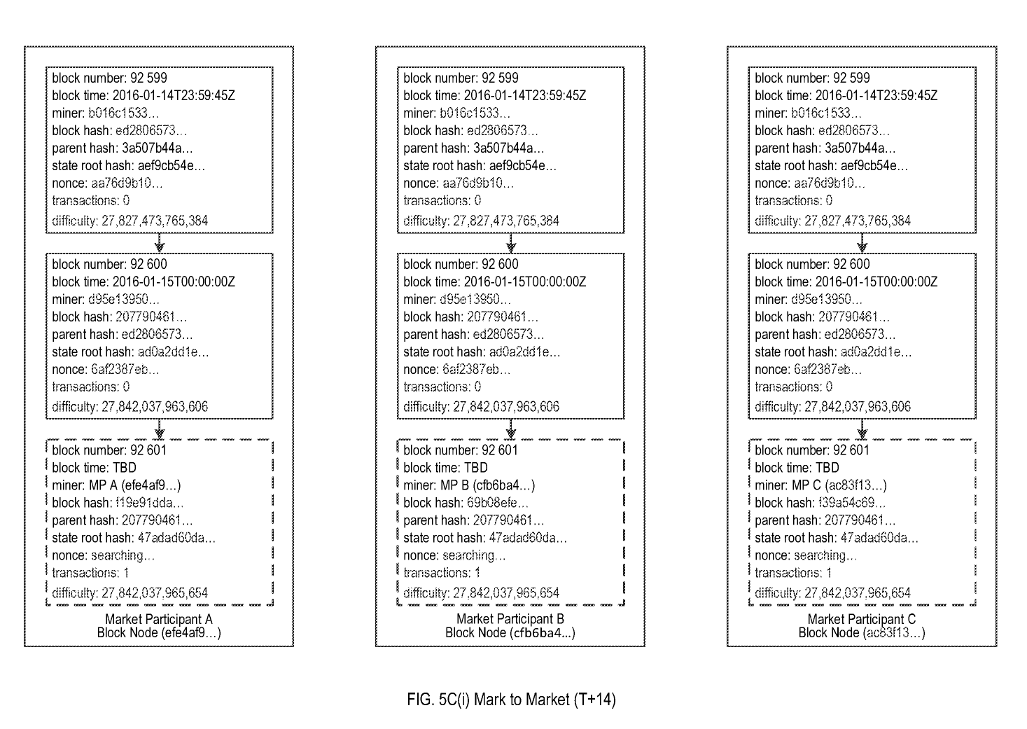

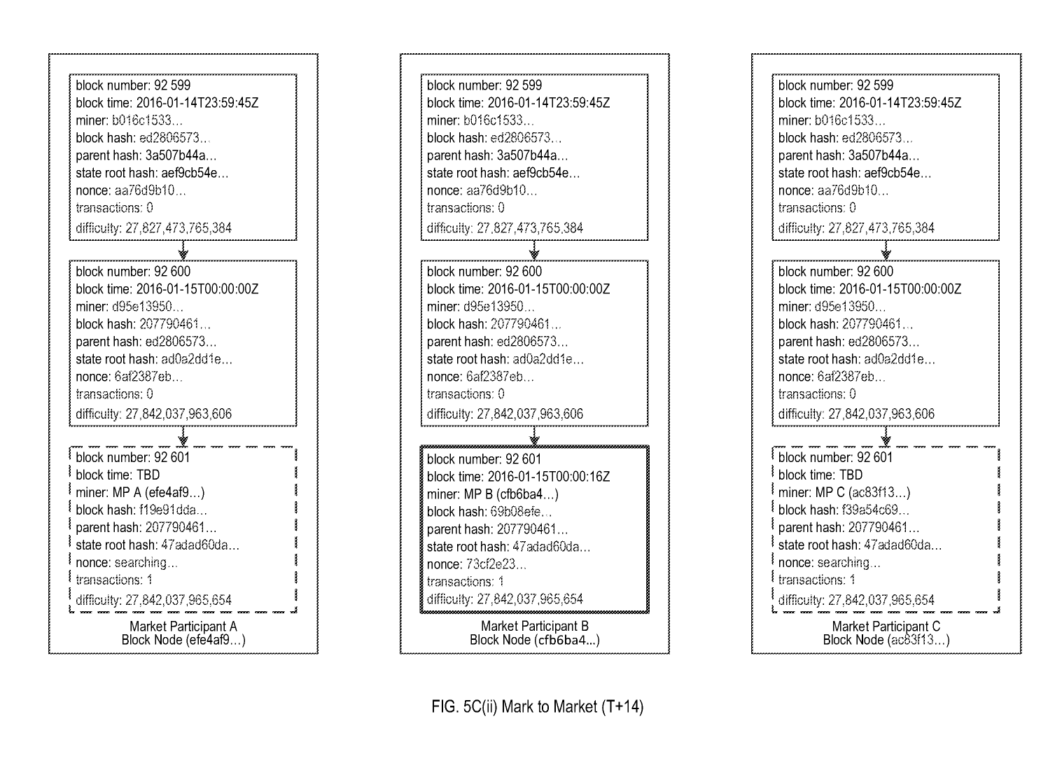

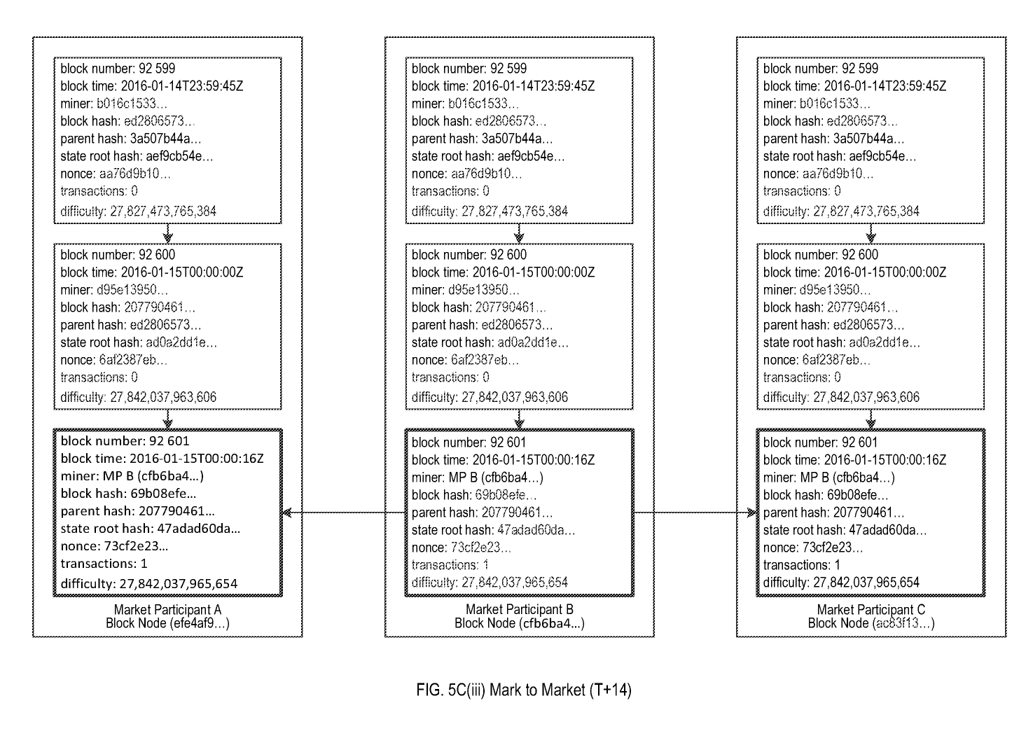

FIGS. 5A to C(i-iii) illustrate processing a mark to market process for a mark to market time and date. For purposes of illustration in FIG. 5A, the mark to market date in FIG. 5 is 14 days after the processing of the second trade affirmation in FIG. 4. In reality, mark to market processing may occur more frequently, for example every day. The main participants in the mark to market processing are the first, second, third and fourth blockchain nodes and the service provider computer. The mark to market process includes determination of the current market value of the contract as well as an exchange of variation margin among the market participants.

The service provider computer determines a spot rate of a price of the first currency relative to a price of the second currency (1.09131) as well as discount rates for the respective currencies. At 50, the service provider computer sends a message that includes the current spot rate and discount rates to the fourth blockchain node and at 52, signs the message with the ECDSA signature of the service provider.

The fourth blockchain node determines a transaction with the name of the market data update function within the computer program that implements a foreign-currency forward contract, identifying the computer program with its unique account address, the unique account address identifying the same account on each blockchain node. The market data update function, when included in a block and executed on each blockchain node, updates the market data with the current time and date (2016-Jan.-15T00:00:00Z) and the current market rate of the first currency relative to the second currency (1.09131) as well as the discount rates. The computer code in the market data update function that was called by the service provider further marks to market the contract on each blockchain node by calculating the current contract value (USD −524.14). The time and date on which the contract valuation for each respective mark to market process takes place is known as the valuation date. The amount of variation margin to be exchanged between the first and second market participants is determined by determining the difference between the contract value at the present valuation date and the contract value at the previous valuation date. In the present example, the present valuation date is the first valuation date and, therefore, the current contract value is in fact equal to the variation margin to be exchange between the first and second market participants. The mark to market procedure revalues the position of each market participant and offsets any potential liquidation profits or losses through the exchange of variation margin, so that any credit exposure between the market participants at any time is limited to the difference between the current contract value and the contract value at the most recent valuation date. The computer code in the market data update function subtracts the variation margin from the available balance of the first market participant (previous balance of USD 8889.78 reduced to USD 8365.64) and increases the available balance of the second market participant by the variation margin (previous balance of USD 8889.78 increased to USD 9413.92). The first, second, third and fourth blockchain nodes thereby enter the market data update, contract state update, and variation margin exchange so that the contract state and new balances on each respective blockchain node are the same.

Traditionally, contract valuation and variation margin exchange requires either direct credit arrangements between the market participants or the involvement of a third party, such third party being, for example, a central clearing counter-party (CCP) or a prime broker. In the cases where a third party is utilized, the market participants establish a credit relationship with the third party instead of each other. In those cases, contracts are valued by and variation margin is exchanged through the third party. Additionally, the third party collects and holds initial margin on behalf of each respective market participant. The involvement of a third party as well as the establishment and maintenance of a direct credit relationship between the market participants result in additional costs and processing time, however, the involvement of the third party reduces the risk to each respective market participant that their counter-parties fail to fulfill their financial obligations to the other, known as counter-party credit risk. The present invention allows market participants to value contracts, hold initial margin, and exchange variation margin using the computer code deployed to the blockchain without the need for a third party and without the need to establish a direct credit relationship. In effect, this allows the market participants to enter into contracts with each other as if a third party had been utilized, enjoying lower counter-party credit risk and settlement convenience. In fact, due to the automated and more expedient nature of the mark to market and variation margin exchange process in the present invention, the mark to market process can take place more frequently than traditionally possible, potentially further lowering credit risk exposures.

Although the present example only shows a single contract between a first and second market participant, it should be understood that the market participants may in fact have entered into multiple contracts that are open on any given valuation date. Although the present example shows only a first, second and third market participant, with only the first and second market participants having entered into a contract, it should be further understood that the first and second market participants may also have entered into contracts with the third market participant as well as additional market participants that are not shown. For example, the first market participant may have entered into two additional contracts with each the third and a fourth market participant, respectively, with each contract potentially having different underlying assets and other details. The computer code deployed to and called on the blockchain to manage each contract may be the same computer code for each contract or different computer code. It should be further understood that the service provider computer provides any additional market data required to mark to market any such additional contracts when the service provider computer calls the market data update function. When the market data update function is called, the function in fact determines the market value of each open contract and determines the variation margin owed by or due to each respective market participant for each open contract. Instead of causing a separate exchange of variation margin to take place for each open contract for each market participant on each valuation date, for some contracts and market participants, the computer code instead computes the net amount of variation margin that is due to or from each market participant and debits or credits the balance of each market participant with only the net amount. This process, known as multilateral netting, can significantly reduce credit exposures (and thereby the amount of funds required to fulfill variation margin requirements) among market participants because market participants often carry positions that offset another position. Although many positions can be netted in this way, netting may only be available among certain contracts and market participants, requiring other contracts and market participants to be netted separately or not at all. In the present example, the computer code deployed to the blockchain also includes logic and data storage to determine which contracts and market participants are to be netted with each other at each valuation date. Although the present embodiment only describes four blockchain nodes, a network may be comprised of any number of nodes, a node being a physical or virtual device that carries out computations on a blockchain network in accordance with the protocol established by the network. Further, the blockchain network may or may not make use of metrics such as “gas” to account for transaction costs and to limit transaction execution time and may or may not implement a native currency.

At 54, the fourth blockchain node syncs the new transaction with the first, second and third blockchain nodes. Although it is only shown that the transaction is synced from the fourth blockchain node to the third blockchain node at 54, it should be understood that the same transaction is sent to the first, third and third blockchain nodes and that the first, third and third blockchain nodes receive and validate the transaction with the market data update causing the marking to market and variation margin exchange so that the updated contract state and balances are the same as the contract state and balances on the fourth blockchain node.

At 58, the third blockchain node discovers a new block. The first, second and fourth blockchain nodes receive the block from the third blockchain node and validate the block by applying the SHA-256 function to the block's nonce and ensuring that the result has the characteristics determined based on the difficulty. When the new block is discovered by and synced to the third blockchain node and the first, second and fourth blockchain nodes, respectively, each blockchain node once again receives, validates and processes the transaction now contained in the new block, validating the transaction by applying the recovery function of ECDSA to the transaction signature and to the byte-array representation of the complete transaction, the transaction signature including the recovery bit v, using the output of the recovery function to determine the blockchain address of the sender, processing the transaction by executing the market data update function within the computer program recorded on the blockchain and loaded into the state database at the account address contained in the transaction, within a virtual machine running on the blockchain node. The computer code of the function instructs the node to record the foreign-exchange spot rate and discount rates as part of the account state of the account that contains the computer code that implements the forward contract and was deployed to the blockchain with the first transaction on the copy of the blockchain recorded on each respective blockchain node. The computer code of the function further instructs the node to compute a new contract value and notional value based on updated discount rates and spot exchange rate. The computer code of the function further instructs the node to compute the amount of variation margin to be exchanged between the market participants, as described and causes the computed variation margin amount to be transferred between the first and second market participants, causing the available balances of the first and second market participants to be updated. As described, the state of the blockchain is identical on each node after the block is synced and the transaction processed.

60 represents that the new contract value is re-computed on each node based on the updated spot rate and discount rates provided by the service provider computer that were sent as a transaction to the fourth blockchain node. The first, second and third blockchain nodes thus all receive the current contract value computed as a result of calling the market data update function. 62 represents that the first, second and third blockchain nodes all validate the mark to market variation margin computation and the contract state changes reported by the fourth blockchain node. Because the variation margin is computed using the computer code deployed to each blockchain node in the first transaction together with the updated market data from the service provider computer as input, the variation margin amount to be exchanged and the updated balances are the same on each blockchain node. All blockchain nodes will only perform their mark to market and variation margin exchanges and update their contract state and balances if they are in agreement among the blockchain nodes. 64A, B and C represent that the balances are updated on all the blockchain nodes.

FIG. 5B shows a state transition on a single node. On the left is the previous state, in the center is the transaction that changes the state and the virtual machine that executes the transaction, resulting in the new state. On the right is the new state. The arrows show that the previous state and the transaction are provided to the virtual machine as input and that the virtual machine provides the new state as output.

In FIGS. 5C(i)-(iii), three blockchain nodes are shown, in three phases of validation and synchronization. In the first phase, two blocks are already known and synced to each node but the third block is currently being mined by each of the nodes. All three nodes are mining their own versions of the third block at the same time, but only one node will discover the block that will ultimately be accepted by the network. In the second phase, the second node discovers a new block by finding a valid nonce (note that the nonce has now been found and a timestamp has been set for the block; the nonce is the number that the node has to find in order to mine a valid block). In the third phase, the new block that was discovered by the second node is synced to the other nodes. When the other nodes receive the block, they validate the block by checking that the nonce and block hash are correct and then add the block to their own local copy of the blockchain. At that time, the other nodes stop mining their own versions of the block and instead start mining the next block (not shown). Each block has a number, a hash that uniquely identifies the block and a hash that uniquely identifies the parent block. Any changes to the block result in a change to the block hash to ensure that each node has the exact same copy of the blockchain with the correct copies of each transaction with the same state.

Transactions (i.e. the one shown in FIG. 5B) are sent to the nodes while the nodes are mining new blocks (not shown). Any transactions received while mining will be included in the new block (up to the block's transaction limit), resulting in a change of the block hash and state root.

### Settlement

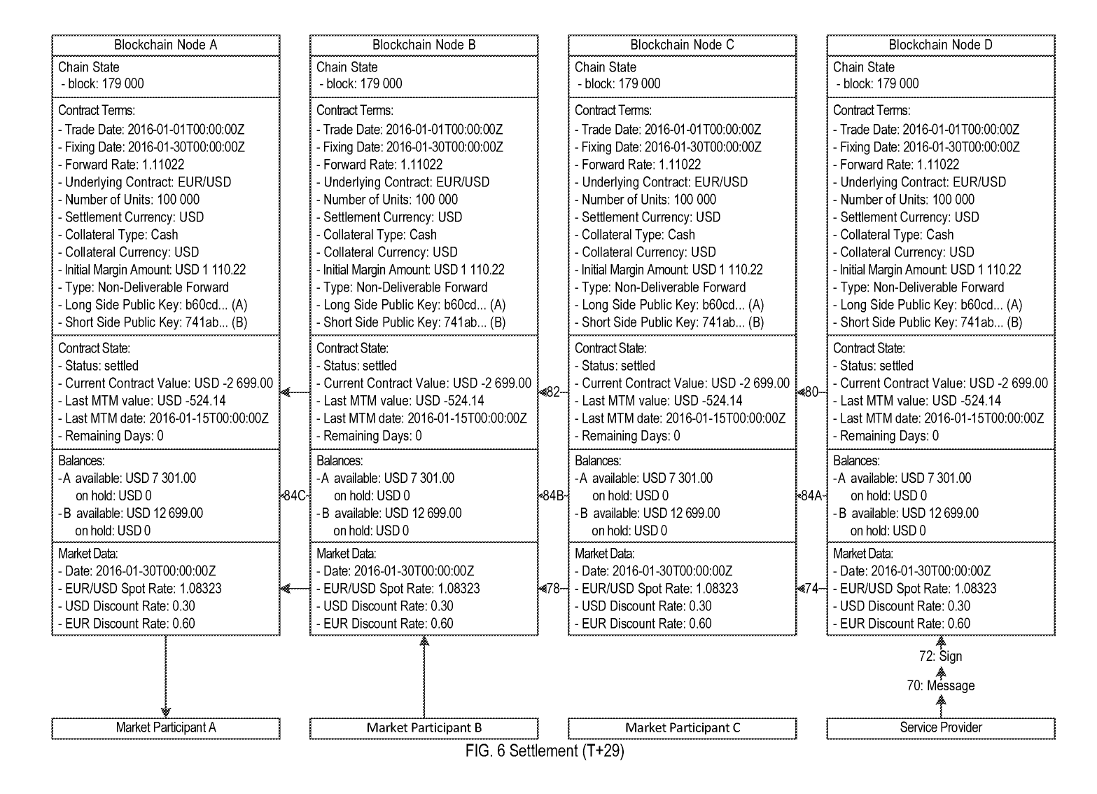

FIG. 6 illustrates the processing of a settlement. The settlement involves the processing of a second marking to market for the settlement time and date. For purposes of illustration, the settlement date in FIG. 6 is 29 days after the second trade affirmation in FIG. 4. In reality, multiple markings to market may occur between the marking to market in FIG. 5 and the settlement in FIG. 6.

The service provider computer determines a mark to market rate of a price of the first currency relative to a price of the second currency (1.08323). At 70, the service provider computer sends a message that includes the current spot rate and discount rates to the fourth blockchain nodes and at 72 signs the message with the ECDSA signature of the service provider.

The fourth blockchain node determines a transaction with the name of the market data update function within the computer program that implements a foreign-currency forward contract, identifying the computer program with its unique account address, the unique account address identifying the same account on each blockchain node. The market data update function, when included in a block and executed on each blockchain node, updates the market data with the current time and date (2016-Jan.-30T00:00:00Z) and the current market rate of the first currency relative to the second currency (1.08323) as well as the discount rates. The computer code in the market data update function that was called by the service provider further marks to market the contract on each blockchain node by calculating the current contract value (USD −2699.00). The time and date on which the contract valuation for each respective mark to market process takes place is known as the valuation date. The amount of variation margin to be exchanged between the first and second market participants at the settlement time (USD 2174.86) is determined by determining the difference between the contract value at the present valuation date (USD −2699.00) and the contract value at the previous valuation date (USD −524.14). The mark to market process revalues the position of each market participant and offsets any potential liquidation profits or losses through the exchange of variation margin, so that any credit exposure between the market participants at any time is limited to the difference between the current contract value and the contract value at the most recent valuation date. The computer code in the market data update function subtracts the computed variation margin amount (USD 2174.86) from the available balance of the first market participant (previous balance of USD 8365.64 reduced to USD 6190.78) and increases the available balance of the second market participant by the computed variation margin amount (previous balance of USD 9413.92 increased to USD 11588.78). The available balances of the first and second market participants are further updated to reflect a release of the initial margin hold as described below, increasing the available balances to the final amounts that are shown in FIG. 6. The first, second, third and fourth blockchain nodes thereby enter the market data update, contract state update indicating that the contract has been settled, final variation margin exchange, and release of initial margin hold so that the contract state and new balances on each respective blockchain node are the same.

At 74, the fourth blockchain node syncs the new transaction with the first, second and third blockchain nodes. Although it is only shown that the transaction is synced from the fourth blockchain node to the third blockchain node at 74, it should be understood that the same transaction is sent to the first, second and third blockchain nodes and that the first, second and third blockchain nodes receive and validate the transaction causing the marking to market, variation margin exchange, release of initial margin, and contract settlement so that the updated contract state and balances are the same as the contract state and balances on the fourth blockchain node.

At 78, the third blockchain node discovers a new block. The first, second and fourth blockchain nodes receive the block from the third blockchain node and validate the block by applying the SHA-256 function to the block's nonce and ensuring that the result has the characteristics determined based on the difficulty.

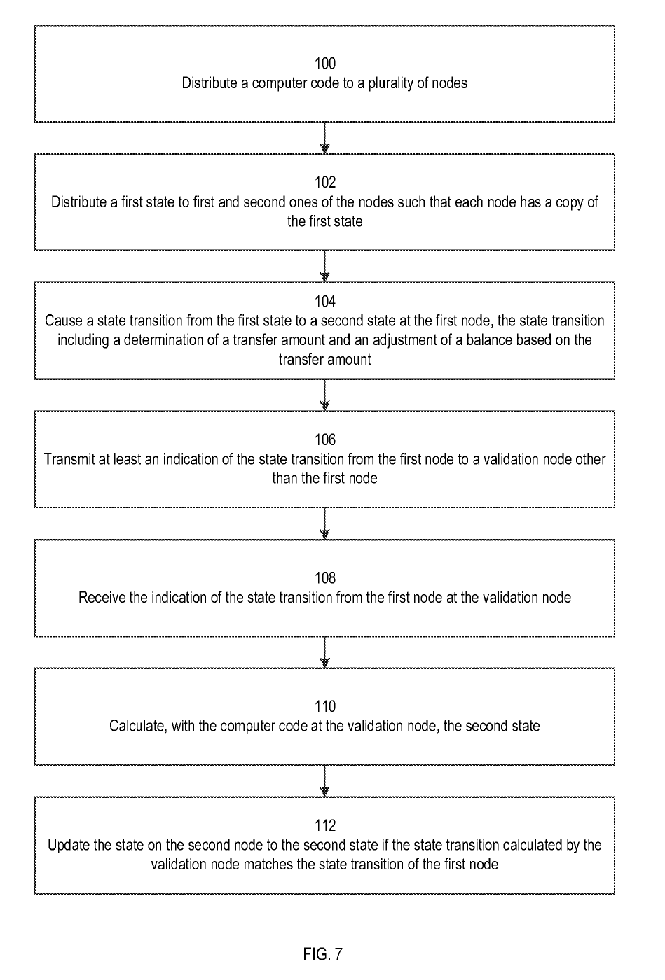

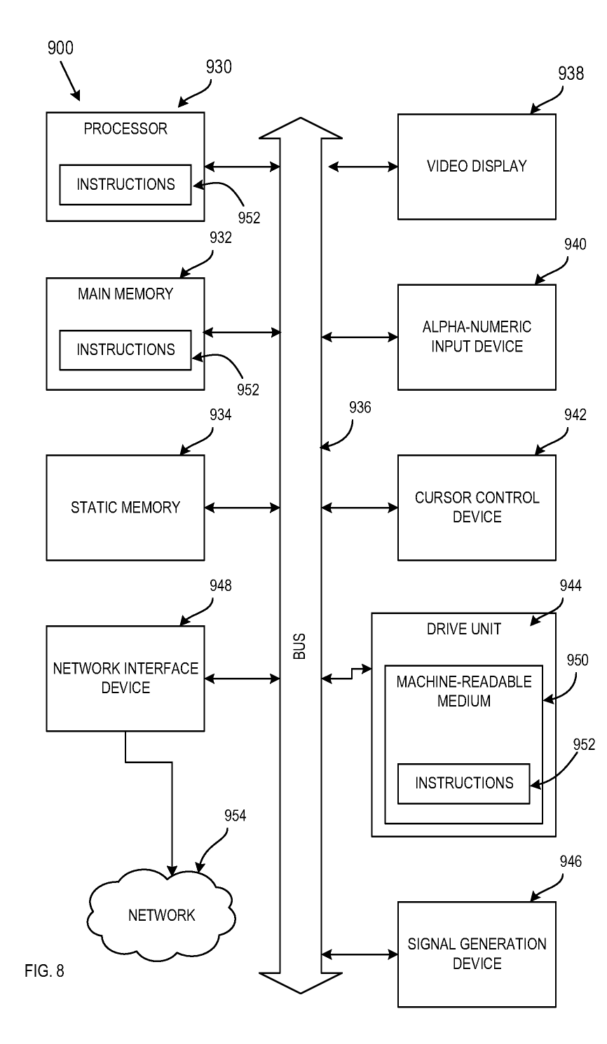

As mentioned with respect to FIG. 1, the fourth node distributes the computer code to the other nodes (FIG. 7: 100) and distributes one or more of the states described with reference to FIGS. 1 to 5 to the other nodes (FIG. 7: 102). It should be understood that the fourth blockchain node originates the transaction that causes the market data update and contract settlement (FIG. 7: 104) and although the transaction is initially synced (FIG. 7: 106; 108) to the first, second and third blockchain nodes, the transaction and the state transition that results from the transaction's application to the current state are not recorded and committed to the immutable blockchain records on the first, second, third and fourth blockchain nodes until the transaction is validated and mined by the third blockchain node as part of a new, valid block (or until the transaction is mined by such other validating blockchain node or set of validating blockchain nodes that may determine a new, valid block or other validation that includes the transaction). The first, second, third and fourth blockchain nodes instead keep the proposed transaction and the resulting state transition as “pending” in temporary working memory (known as the “mempool”) until a new, valid block that includes the transaction is received, discarding the transaction if such new block is not received after a period of time determined by each respective blockchain node, identifying the new state by a value known as the state's “root hash”. Each respective blockchain node independently computes the new state that results from the application of the proposed transaction to the current state on each respective blockchain node (FIG. 7: 110). When the third blockchain node determines a new valid block (a valid block being a particular form of validation that the validating blockchain node deems acceptable to each respective blockchain node) containing the transaction, the new state that was computed on the third blockchain node by applying the transaction to the current state on the third blockchain node is identified in the block by its root hash. The new block with the transaction and the new root hash identifying the new state is synced to the first, second and fourth blockchain nodes. The first, second and fourth blockchain nodes, respectively, receive and validate the new block with the root hash identifying the new state as it was computed on the third blockchain node, validating the block by comparing the state identified in the new block by its root hash to the root hash of the new state that was computed independently on the first, second and fourth blockchain nodes. In effect, each the first and second blockchain nodes compare the new state that was computed on the fourth blockchain node to the new state that was computed on the third blockchain node (the third blockchain node acting as the validating node in this case), the first and second blockchain nodes only updating their current state to the new state if the new state computed by the fourth blockchain node matches the new state computed by the third blockchain node (FIG. 7: 112).

Further, the first and second blockchain nodes also validate the block received from the third blockchain node by comparing the new state that was computed by the third blockchain node to the new state that was computed on the first and second blockchain nodes, the first and second blockchain nodes only accepting the new block with the new state if the new state validated by the third blockchain node matches the new state computed by applying the transaction on the first and second blockchain nodes.

Although in the present example it is described that the third blockchain node acts as the validating node by determining a new block and syncing the new block to the first, second and fourth blockchain nodes, any one of the first, second third or fourth blockchain nodes may act as the validating node by determining a new block. In order for a new block to be accepted by the non-validating nodes, the block must have been determined by a node that the non-validating nodes accept as a validating node, in addition to having a valid block header containing a valid nonce and reference to an existing block and containing valid transactions, as described.

Although in the present example only a single validating node is described, it should be further understood that instead of relying on a single validating node, the non-validating nodes may instead rely on multiple validating nodes to validate each block, for example, by requiring that each block be validated by a majority of validating notes, further requiring that each block be validated by at least a minimum number of validating nodes.

When the new block is discovered by and synced to the third blockchain node and the first, second and fourth blockchain nodes, respectively, each blockchain node once again receives, validates and processes the transaction now contained in the new block, validating the transaction by applying the recovery function of ECDSA to the transaction signature and to the byte-array representation of the complete transaction, the transaction signature including the recovery bit v, using the output of the recovery function to determine the blockchain address of the sender, processing the transaction by executing the market data update function within the computer program recorded on the blockchain and loaded into the state database at the account address contained in the transaction, within a virtual machine running on the blockchain node. The computer code of the market data update function instructs the node to record the foreign-exchange spot rate and discount rates as part of the account state of the account that contains the computer code that implements the forward contract and was deployed to the blockchain with the first transaction on the copy of the blockchain recorded on each respective blockchain node. The computer code of the function further instructs the node to compute a new contract value and notional value based on updated discount rates and spot exchange rate. The computer code of the function further instructs the node to compute the amount of variation margin to be exchanged between the market participants, as described and causes the computed variation margin amount to be transferred between the first and second market participants, causing the available balances of the first and second market participants to be updated. The computer code of the function further causes the contract status to be changed to “settled” and causes the initial margin amounts for the first and second market participants to be debited from the on hold balances of the first and second market participants and the same amounts to be credited to the available balances of the first and second market participants because the current date is the same as the settlement date/fixing date of the contract. As described, the state of the blockchain is identical on each node after the block is synced and the transaction processed.

80 represents that the new contract value is re-computed on each node based on the updated spot rate and discount rates provided by the service provider computer that were sent as a transaction to the fourth blockchain node. The first, second and third blockchain nodes thus all receive the current contract value computed as a result of calling the market data update function. 82 represents that the first, second and third blockchain nodes all validate the mark to market variation margin computation, initial margin release and the contract state changes reported by the fourth blockchain node. Because the variation margin is computed using the computer code deployed to each blockchain node in the first transaction together with the updated market data from the service provider computer as input, the variation margin amount to be exchanged and the updated balances are the same on each blockchain node. All blockchain nodes will only perform their mark to market and variation margin exchanges and update their contract state and balances if they are in agreement among the blockchain nodes. 84A, B and C represent that the balances are updated on all the blockchain nodes.

When the current date (2016-Jan.-30T00:00:00Z in the market data) is the same as the settlement date/fixing date (2016-Jan.-30T00:00:00Z in the contract terms), the last mark to market variation margin exchange takes place and the contract state is automatically changed to “settled” on the blockchain as part of the data that is stored in the account that contains the computer code that implements the forward contract. No further variation margin will be exchanged for the contract. The initial margin amount (USD 1110.22) is automatically released from the on hold value and credited to each mark participants available balance on the blockchain (increasing the account balance of the first market participant from USD 6190.78 to USD 7301.00 and increasing the account balance of the second market participant from USD 11588.78 to USD 12699.00).

By placing the transaction on the blockchain, cross checking is carried out by all the nodes to validate signatures of market participants and a service provider, cross checking of variation margin calculation, cross checking of adjustments to account balance, etc. The requirement for the decentralized functioning of the blockchain nodes effectively removes control that would otherwise reside within a service provider computer. The synchronization of data across blockchain nodes provides market participants with more transparency of mark to market and settlement processing.

FIG. 7 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 930 (e.g., a central processing unit (CPU), a graphics processing unit (GPU), or both), a main memory 932 (e.g., read-only memory (ROM), flash memory, dynamic random access memory (DRAM) such as synchronous DRAM (SDRAM) or Rambus DRAM (RDRAM), etc.), and a static memory 934 (e.g., flash memory, static random access memory (SRAM, etc.), which communicate with each other via a bus 936.

The computer system 900 may further include a video display 938 (e.g., a liquid crystal displays (LCD) or a cathode ray tube (CRT)). The computer system 900 also includes an alpha-numeric input device 940 (e.g., a keyboard), a cursor control device 942 (e.g., a mouse), a disk drive unit 944, a signal generation device 946 (e.g., a speaker), and a network interface device 948.

The disk drive unit 944 includes a machine-readable medium 950 on which is stored one or more sets of instructions 952 (e.g., software) embodying any one or more of the methodologies or functions described herein. The software may also reside, completely or at least partially, within the main memory 932 and/or within the processor 930 during execution thereof by the computer system 900, the memory 932 and the processor 930 also constituting machine readable media. The software may further be transmitted or received over a network 954 via the network interface device 948.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

1-45. (canceled)

46. A method of updating a balance, comprising:
distributing a computer code to a plurality of nodes;
distributing a first state to first and second ones of the nodes such that each node has a copy of the first state;
causing a state transition from the first state to a second state at the first node, the state transition including a determination of a transfer amount and an adjustment of a balance based on the transfer amount;
transmitting at least an indication of the state transition from the first node to a validation node other than the first node;
receiving the indication of the state transition from the first node at the validation node;
calculating, with the computer code at the validation node, the second state; and
updating the state on the second node to the second state if the state transition calculated by the validation node matches the state transition of the first node.

47. The method of claim 46, wherein the validation node is a third node other than the first node or the second node, further comprising:
transmitting a validation from the third node to the second node; and
receiving the validation from the third node at the second node, wherein the second node only updates the first state to the second state if the validation is received.

48. The method of claim 47, wherein the first node sends the state transition to the second and third nodes before the second node receives the validation from the third node.

49. The method of claim 46, further comprising:
transmitting a validation from the validation node to the first node;
receiving the validation from the validation node at the first node; and
applying the state transition at the first node only if the validation is received.

50. The method of claim 46, wherein the transfer is from a balance of a first user to a balance of a second user.

51. The method of claim 46, wherein the transfer is from a first balance of a first user controlled by the code without allowing the first user to withdraw funds to reduce the first balance to a second balance of the first user from which the first user is able to make a withdrawal.
